(19) United States
(12) Patent Application Publication
(10) Pub. No.: US 2026/0289236 A1
(43) Pub. Date: Sep. 24, 2026

(54) COMMUNICATION SYSTEMS, APPARATUSES, METHODS, AND NON-TRANSITORY COMPUTER-READABLE STORAGE MEDIA USING COLLABORATIVE NEURAL NETWORKS FOR COMMUNICATION RECEIVERS

(71) Applicant: HUAWEI TECHNOLOGIES CO., LTD., Shenzhen (CN)

(72) Inventors: Mohamad Ali Adulwahid Obeed, Ottawa (CA); Ming Jian, Kanata (CA)

(21) Appl. No.: 19/083,083

(22) Filed: Mar. 18, 2025

(51) Int. Cl. G06N 3/045; H04L 1/20

(52) U.S. Cl. CPC G06N 3/045; H04L 1/203

(57) ABSTRACT

A signal detection module has: a first branch for receiving an input signal and outputting a first output signal; one or more second branches each for receiving at least a portion of the input signal and outputting a second output signal; a first normalization layer for normalizing a combination of the first and second output signals to obtain a normalized signal; and an output layer receiving the normalized signal and generating a detected signal. The first branch has an input layer and one or more modified residual blocks (RBs) connected in series. Each second branch has an input layer and one or more RBs connected in series. The output of at least one of the one or more RBs is also connected to the first branch, and combined with an output of one of the one or more modified RBs.

### FIELD OF THE DISCLOSURE

The present disclosure relates generally to communication systems, apparatuses, methods, and non-transitory computer-readable storage devices or media, and in particular to communication systems, apparatuses, methods, and non-transitory computer-readable storage devices or media using collaborative neural networks for receivers such as radio receivers.

### BACKGROUND

Communication systems such as wireless communication systems are known. Generally, in a communication system, a transmitter (Tx) transmits one or more symbols as a communication signal through communication medium such as a free space, air, a cable, a wire, or the like. A receiver (Rx) receives the communication signal and retrieves the transmitted symbols. The received signal may be distorted by the communication medium or channel, and mixed with various noises (such as white noise, non-Gaussian noise, inter-channel interferences, and/or the like). Therefore, in some communication systems, the Tx and/or Rx may need to estimate and compensate for the channel effect, supress the noises to improve the signal-to-noise (SNR) ratio (or the signal-to-interference-and-noise ratio (SINR)) so as to detect the transmitted symbols with low error probability. Numerous methods have been used for minimizing the error probability at the Rx.

### SUMMARY

According to one aspect of this disclosure, there is provided a signal detection module comprising: a first branch for receiving an input signal and outputting a first output signal; one or more second branches each for receiving at least a portion of the input signal and outputting a second output signal; a first normalization layer for normalizing a combination of the first output signal and the one or more second output signals via a first combination operation to obtain a normalized signal; and an output layer receiving the normalized signal and generating a detected signal; wherein the first branch comprises a first input layer and one or more first residual blocks (RBs) connected in series; wherein each second branch comprises a second input layer and one or more second RBs connected in series; wherein each first RB comprises: a first neural network module for receiving a normalized version of an input of said first RB and generating an output of the first neural network module, and a shortcut path for directing the normalized version of the input of said first RB for adding to the output of the first neural network module to generate an output of said first RB; wherein each second RB comprises: a second neural network module for receiving a normalized version of an input of said second RB and generating an output of the second neural network module, and a shortcut path for directing the input of said second RB for adding to the output of the second neural network module to generate an output of said second RB.

In some implementations, the output of at least one of the one or more second RBs of the one or more second branches is also connected to the first branch, and combined with an output of one of the one or more first RBs via a second combination operation.

In some implementations, each of the first and second combination operations comprises: an elementwise multiplication; an addition; a concatenation; or a combination thereof.

In some implementations, each first RB comprises a second normalization layer for generating the normalized version of the input of said first RB, and each second RB comprises a third normalization layer for generating the normalized version of the input of said second RB.

In some implementations, each of the first, second, and third normalization layers comprises a batch normalization (NB) layer or a layer normalization (LN) layer.

In some implementations, each of the first input layer, the second input layer, and the output layer comprises a convolutional layer.

In some implementations, each of the first and second first neural network modules comprises a convolutional neural network (CNN) module.

In some implementations, each of the first and second first neural network modules comprises: one or more rectified linear units (ReLUs); one or more NBs; and one or more convolutional layers.

In some implementations, each of the first and second first neural network modules comprises a first ReLU, a convolutional layer, a first NB, a second ReLU, and a second convolutional layer.

In some implementations, the first branch further comprises a third RB between the first input layer and the one or more first RBs, the third RB having a same structure as that of the one or more second RBs.

In some implementations, the output of one of the one or more second RBs of the one or more second branches is also connected to the first branch, and combined with an output of the third RB via a third combination operation.

In some implementations, an output of at least one of the one or more first RBs is also connected to one of the one or more second branches, and added to the output of one of the one or more second RBs.

According to one aspect of this disclosure, there is provided a method using the above-described module, the method comprising: receiving a signal transmitted from a transmitter; obtaining the input signal; and sending the input signal to the signal detection module of claim 1 to obtain the detected signal.

According to one aspect of this disclosure, there is provided a signal detection apparatus comprising: one or more processors; and one or more memories storing instructions; wherein the instructions, when executed, cause the module to perform a function of the above-described module.

According to one aspect of this disclosure, there is provided one or more non-transitory, computer-readable storage media comprising computer-executable instructions, wherein the instructions, when executed, cause one or more processors to perform a function of the above-described module.

According to one aspect of this disclosure, there is provided a signal detection method comprising: passing an input signal through a first branch; passing at least a respective portion of the input signal through each of one or more second branches; combining output signals of the first branch and the one or more second branches to obtain a combined signal; normalizing the combined signal; and passing the normalized signal through an output layer for outputting a detected signal; wherein each of the first branch and the one or more second branches comprises an input layer and one or more residual blocks (RBs) connected in series; wherein each RB is for: passing a normalized version of an input signal of the RB through a neural network module for generating an inference, and summing the input signal of the RB and the inference for generating an output signal of the RB.

In some implementations, said combining the output signals of the first branch and the one or more second branches comprises: combining the output signals of the first branch and the one or more second branches via: an elementwise multiplication; an addition; a concatenation; or a combination thereof.

In some implementations, said normalizing the combined signal comprises: normalizing the combined signal using a first normalization layer; and said passing the normalized version of the input signal of the RB through the neural network module comprises: normalizing the input signal of the RB using a second normalization layer to obtain the normalized version of the input signal of the RB, and passing the normalized version of the input signal of the RB through the neural network module for generating the inference.

In some implementations, the input layer of each of the first branch and the one or more second branches is a convolutional layer; and the neural network module of each RB comprises a convolutional neural network (CNN) module.

In some implementations, each of the first branch and a first one of the one or more second branches comprises a plurality of RBs; and the signal detection method further comprises: combining the output signal of a first RB of the plurality of RBs of the first one of the one or more second branches with the output signal of a second RB of the first branch for generating the input signal of a third RB of the first branch subsequent to the second RB of the first branch; and wherein, in the third RB of the first branch, the step of summing the input signal of the RB and the inference for generating the output signal of the RB is replaced with: summing the normalized version of the input signal of the third RB and the inference thereof for generating the output signal of the third RB.

In some implementations, said combining in each of the step of combining the output signals of the first branch and the one or more second branches and the step of combining the output signal of the first RB of the plurality of RBs of the first one of the one or more second branches with the output signal of the second RB of the first branch is conducted via: an elementwise multiplication; an addition; a concatenation; or a combination thereof.

In some implementations, the signal detection method further comprises: directing an output of one of the one or more RBs of the first branch to a second one of the one or more second branches, and adding to the output of one of the one or more RBs of the second one of the one or more second branches.

According to one aspect of this disclosure, there is provided a signal detection module comprising: one or more processors; and one or more memories storing instructions; wherein the instructions, when executed, cause the module to perform any of the above-described methods.

According to one aspect of this disclosure, there is provided one or more non-transitory, computer-readable storage media comprising computer-executable instructions, wherein the instructions, when executed, cause one or more processors to perform any of the above-described methods.

According to one aspect of this disclosure, there is provided one or more circuits such as one or more processors for performing any of the above-described methods.

According to one aspect of this disclosure, there is provided one or more processors functionally connected to one or more memories for performing any of the above-described methods.

According to one aspect of this disclosure, there is provided an apparatus comprising: one or more processors functionally connected to one or more memories for performing any of the above-described methods.

According to one aspect of this disclosure, there is provided an apparatus, and configured to perform any of above-described methods and their implementations. Specifically, the apparatus includes one or more units configured to perform any of above-described methods and their implementations.

According to one aspect of this disclosure, there is provided a computer-readable storage medium. The computer-readable storage medium stores a computer program, and when the computer program is executed by an apparatus, the apparatus is enabled to implement any of above-described methods and their implementations.

According to one aspect of this disclosure, there is provided a computer program product including one or more instructions. When the instructions are executed by an apparatus such as a computer, the apparatus is enabled to implement any of above-described methods and their implementations.

According to one aspect of this disclosure, there is provided a computer program. When the computer program is executed by a computer, an apparatus is enabled to implement any of above-described methods and their implementations.

According to one aspect of this disclosure, there is provided a communication system. The communication system includes a first communication-node and/or a second communication-node, the first communication-node is configured to perform any of the above-described methods regarding with the first communication-node as stated above, and the second communication-node is configured to perform any of the above-described methods regarding with the second communication-node as stated above.

According to one aspect of this disclosure, there is provided an apparatus for implementing any of the above-described methods in any possible implementation of the foregoing aspects.

The modules, methods, apparatuses, systems, and computer-readable storage media disclosed herein provide various benefits.

For example, the modules disclosed herein leverage the collaboration of multiple ResNets to improve the detection performance of the radio receivers. Compared to most signal detectors, the module disclosed herein reduces the bit error rate (BER), and may achieve the same performance target as said most signal detectors with fewer number of parameters and fewer computational operations, thereby reducing the memory and computational cost.

By using a normalization layer after each element-wise multiplication that occurred between the ResNets, the features that go through the neural network module and the shortcut path are normalized, which helps stabilizing the neural networks and avoiding the gradient explosion phenomena.

Different from the standard ResNets where the operations are fully sequentially dependent, the modules disclosed herein use multiple ResNets to process features in parallel, thereby reducing the inference delay.

### BRIEF DESCRIPTION OF THE DRAWINGS

For a more complete understanding of this disclosure, reference is made to the following description and accompanying drawings, in which:

FIGS. 1A and 1B are simplified schematic diagrams showing the structure of a communication system, according to some implementations of this disclosure;

FIG. 2A is a simplified schematic diagram showing a user equipment (UE), a terrestrial transmit-and-receive point (T-TRP), and a non-terrestrial transmit-and-receive points (NT-TRP) of the communication system shown in FIG. 1A;

FIG. 2B is a simplified schematic diagram showing units or modules in a device, such as in UE or in TRP of the communication system shown in FIG. 1A;

FIG. 3 is a simplified schematic diagram showing the main components of the communication system shown in FIG. 1A;

FIG. 4 is a simplified schematic diagram showing the structure of a receiver shown in FIG. 3;

FIG. 5 is a simplified schematic diagram showing the structure of a receiver shown in FIG. 3 having a neural-network signal detector;

FIG. 6 is a simplified schematic diagram showing the structure of a pre-activation residual network (ResNet) that may be used in the neural-network signal detector of the receiver shown in FIG. 5;

FIG. 7 is a simplified schematic diagram showing the structure of a residual block (RB) of the pre-activation ResNet shown in FIG. 6;

FIG. 8 shows an example of the pre-activation ResNet shown in FIG. 6, which comprises a plurality of RBs shown in FIG. 7;

FIG. 9 is a simplified schematic diagram showing the structure of a collaborative neural network (CoNet) signal detector of the receiver shown in FIG. 5, according to some implementations of this disclosure;

FIG. 10 is a simplified schematic diagram showing the structure of a modified RB of the CoNet signal detector shown in FIG. 9, according to some implementations of this disclosure;

FIG. 11 is a simplified schematic diagram showing the structure of an example of the CoNet signal detector shown in FIG. 9, according to some implementations of this disclosure;

FIGS. 12 and 13 are plots showing the simulated BER performances of the CoNet signal detector shown in FIG. 11, a DeepRx signal detector, a signal detector using a linear minimum mean square error (LMMSE) method with known channel state information (CSI), and a signal detector using LMMSE with imperfect CSI, respectively;

FIG. 14 is a simplified schematic diagram showing the structure of a CoNet signal detector of the receiver shown in FIG. 5, according to some implementations of this disclosure;

FIG. 15 is a simplified schematic diagram showing the structure of a modified RB of the CoNet signal detector shown in FIG. 14, according to some implementations of this disclosure;

FIG. 16 is a simplified schematic diagram showing the structure of a modified RB of the CoNet signal detector shown in FIG. 14, according to some other implementations of this disclosure; and

FIGS. 17 to 30 are simplified schematic diagrams showing the structure of a CoNet signal detector of the receiver shown in FIG. 5, according to various implementations of this disclosure.

### DETAILED DESCRIPTION

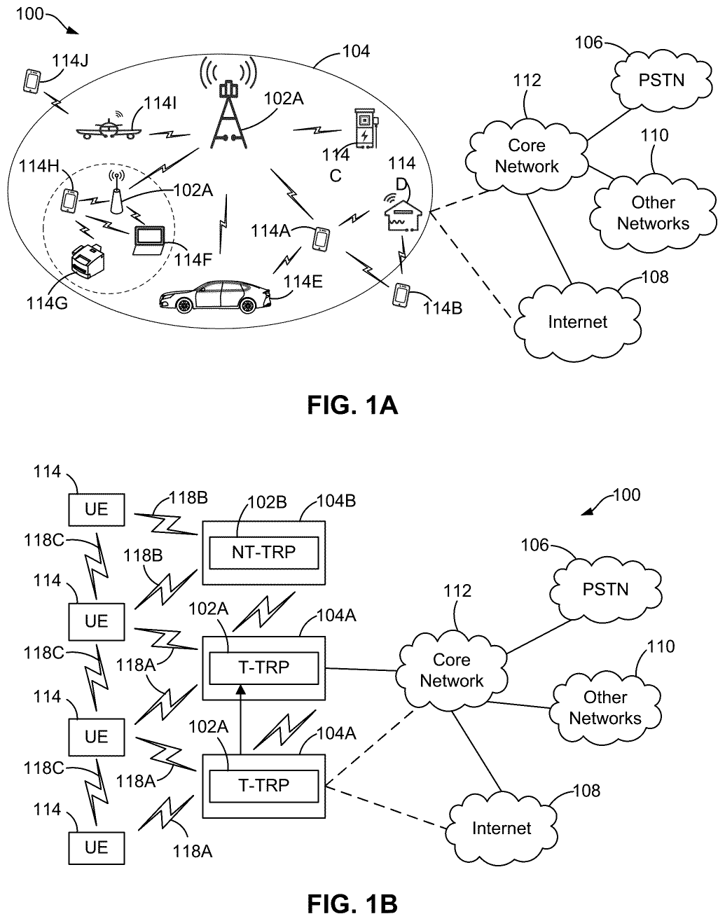

Referring to FIG. 1A, as an illustrative example without limitation, a simplified schematic illustration of a communication system is provided. The communication system 100 is in the form of a mobile communication system and comprises a radio access network (RAN) 104. The RAN 104 may be a next generation (for example, sixth generation (6G) or later) RAN, or a legacy (for example, fifth-generation (5G), fourth-generation (4G), third-generation (3G), or second-generation (2G)) RAN. One or more user equipments (UEs) 114A to 114J (generically referred to as 114) may be interconnected to one another or connected to one or more network nodes 102A in the RAN 104. A core network 112 may be a part of the communication system and may be dependent or independent of the radio access technology used in the communication system 100. Also the communication system 100 comprises a public switched telephone network (PSTN) 106, the internet 108, and other networks 110.

FIG. 1B illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. As those skilled in the art will appreciate, the heterogeneous network may achieve improved overall performance through efficient multi-link joint operation, more flexible functionality sharing, and faster physical layer link switching between terrestrial networks (TNs) and non-terrestrial networks (NTNs).

The terrestrial communication system and the non-terrestrial communication system may be considered sub-systems of the communication system 100. In the example shown, the communication system 100 includes UEs 114, RANs 104A (also called “terrestrial communication networks”), non-terrestrial communication networks 104B, a core network 112, a public switched telephone network (PSTN) 106, the internet 108, and other networks 110. The RANs 104A include respective base stations (BSs) 102A, which may be generically referred to as terrestrial transmit-and-receive points (T-TRPs) 102A. The non-terrestrial communication network 104B includes an access node 102B, which may be generically referred to as a non-terrestrial transmit-and-receive point (NT-TRP) 102B. The T-TRPs 102A and the NT-TRP 102B may be generally referred to as TRPs or access nodes 102.

Any UE 114 may be alternatively or additionally configured to interface, access, or communicate with any other T-TRP 102A and NT-TRP 102B, the internet 108, the core network 112, the PSTN 106, the other networks 110, or any combination of the preceding. In some examples, UE 114 may communicate an uplink and/or downlink transmission over a terrestrial interface 118A with T-TRP 102A. In some examples, A UE 114 may communicate an uplink and/or downlink transmission over a non-terrestrial interface 118B with NT-TRP 102B. In some examples, the UEs 114 may also communicate directly with one another via one or more sidelink air interfaces 118C.

The air interfaces 118A and 118C may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA; also known as discrete Fourier transform spread OFDMA, DFT-s-OFDMA) in the air interfaces 118A and 118C. The air interfaces 118A and 118C may utilize other higher dimension signal spaces, which may involve a combination of orthogonal and/or non-orthogonal dimensions.

The non-terrestrial air interface 118B may enable communication between a UE 114 and one or multiple NT-TRPs 102B via a wireless link or simply a link. For some examples, the link is a dedicated connection for unicast transmission, a connection for broadcast transmission, or a connection between a group of UEs 114 and one or multiple NT-TRPs 102B for multicast transmission.

The RANs 104A are in communication with the core network 112 to provide the UEs 114 with various services such as voice, data, and other services. The RANs 104A and/or the core network 112 may be in direct or indirect communication with one or more other RANs (not shown), which may or may not be directly served by core network 112, and may or may not employ the same radio access technology as RANs 104A. The core network 112 may also serve as a gateway access between (i) the RANs 104A, or UEs 114, or both, and (ii) other networks (such as the PSTN 106, the internet 108, and the other networks 110). In addition, some or all of the UEs 114 may include functionality for communicating with different wireless networks over different wireless links using different wireless technologies and/or protocols. Instead of wireless communication (or in addition thereto), the UEs 114 may communicate via wired communication channels to a service provider or switch (not shown), and to the internet 108. PSTN 106 may include circuit switched telephone networks for providing plain old telephone service (POTS). Internet 108 may include a network of computers and subnets (intranets) or both, and incorporate protocols, such as internet protocol (IP), transmission control protocol (TCP), user datagram protocol (UDP). UEs 114 may be multimode devices capable of operation according to multiple radio access technologies, and incorporate multiple transceivers necessary to support such.

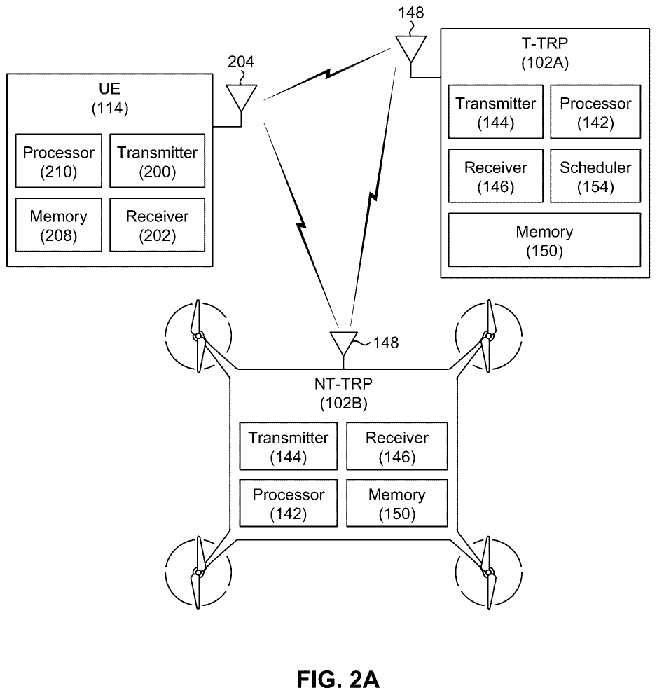

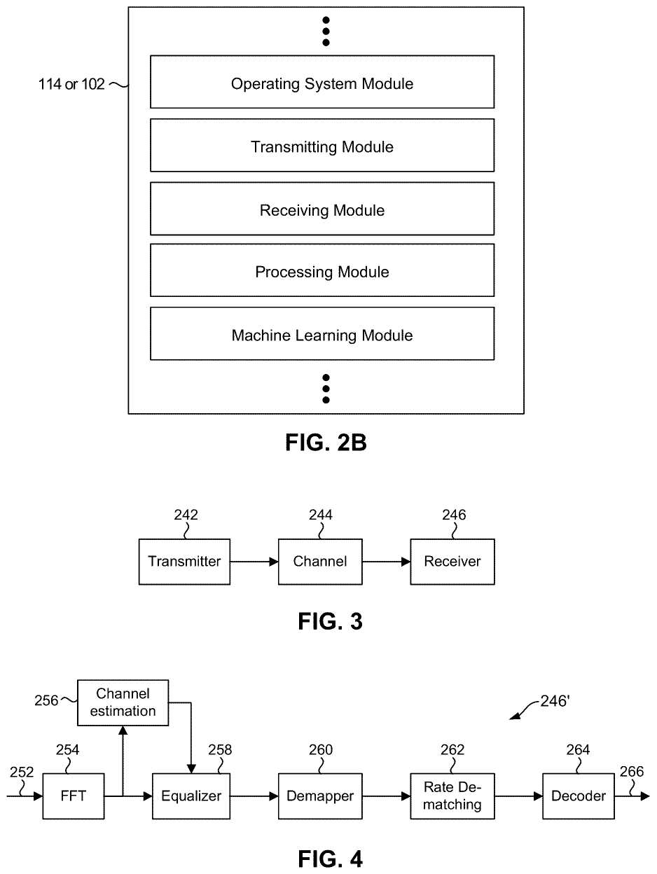

FIG. 2A illustrates an example of a UE 114, a T-TRP 102A, and a NT-TRP 102B. The UE 114 is used to connect persons, objects, machines, and/or the like. The UE 114 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each UE 114 represents any suitable end-user device for wireless operation and may include such devices (or may be referred to) as a user device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, a wearable device (such as a watch, a pair of glasses, a head mounted equipment, and/or the like), an industrial device, a robot, or apparatus (for example, communication module, modem, or chip) in or comprising the forgoing devices, among other possibilities. Future generation UEs 114 may be referred to using other terms. Each UE 114 connected to T-TRP 102A and/or NT-TRP 102B may be dynamically or semi-statically turned-on (that is, established, activated, or enabled), turned-off (that is, released, deactivated, or disabled) and/or configured in response to one of more of: connection availability and connection necessity.

The T-TRP 102A may be known by other names in some implementations, such as a base station, a base transceiver station (BTS), a radio base station, a network node, a network device, a device on the network side, a transmit/receive node, a Node B, an evolved NodeB (eNodeB or eNB), a home eNodeB, a next generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 102A may be macro BSs, pico BSs, relay node, donor node, or the like, or combinations thereof. The T-TRP 102A may refer to the forgoing devices or refer to an apparatus (for example, a communication module, a modem, a chip, or the like) in the forgoing devices.

In some implementations, the parts of the T-TRP 102A may be distributed. For example, some of the modules of the T-TRP 102A may be located remote from the equipment housing the antennas of the T-TRP 102A, and may be coupled to the equipment housing the antennas over a communication link (not shown) sometimes known as front haul, such as common public radio interface (CPRI). Therefore, in some implementations, the term T-TRP 102A may also refer to modules on the network side that perform processing operations, such as determining the location of the UE 114, resource allocation (scheduling), message generation, and encoding/decoding, and that are not necessarily part of the equipment housing the antennas of the T-TRP 102A. The modules may also be coupled to other T-TRPs. In some implementations, the T-TRP 102A may actually be a plurality of T-TRPs that are operating together to serve the UE 114, for example, through coordinated multipoint transmissions.

The T-TRP 102A comprises one or more circuits (such as one or more electronic circuits and/or one or more optical circuits) forming various components. For example, the T-TRP 102 may comprise at least one transmitter 144 and at least one receiver 146 coupled to one or more antennas 148. Only one antenna 148 is illustrated. One, some, or all of the antennas may alternatively be panels. The transmitter 144 and the receiver 146 may be integrated as a transceiver. The T-TRP 102A may further comprise at least one processor 142 for performing operations including those related to: preparing a transmission for downlink transmission to the UE 114, processing an uplink transmission received from the UE 114, preparing a transmission for backhaul transmission to NT-TRP 102B, and processing a transmission received over backhaul from the NT-TRP 102B. Processing operations related to preparing a transmission for downlink or backhaul transmission may include operations such as encoding, modulating, precoding (for example, multiple input multiple output (MIMO) precoding), transmit beamforming, and generating symbols for transmission. Processing operations related to processing received transmissions in the uplink or over backhaul may include operations such as receive beamforming, and demodulating and decoding received symbols. The processor 142 may also perform operations relating to network access (for example, initial access) and/or downlink synchronization, such as generating the content of synchronization signal blocks (SSBs), generating the system information, and/or the like. In some implementations, the processor 142 also generates the indication of beam direction, for example, BAI, which may be scheduled for transmission by a scheduler 154. The processor 142 performs other network-side processing operations described herein, such as determining the location of the UE 114, determining where to deploy NT-TRP 102B, and/or the like. In some implementations, the processor 142 may generate signaling, for example, to configure one or more parameters of the UE 114 and/or one or more parameters of the NT-TRP 102B. Any signaling generated by the processor 142 is sent by the transmitter 144. Note that “signaling”, as used herein, may alternatively be called control signaling. Dynamic signaling may be transmitted in a control channel, for example, a physical downlink control channel (PDCCH), and static or semi-static higher layer signaling may be included in a packet transmitted in a data channel, for example, in a physical downlink shared channel (PDSCH), in which case the signaling may be known as higher-layer signaling, static signaling, or semi-static signaling. Higher-layer signaling may also refer to radio resource control (RRC) protocol signaling or media access control-control element (MAC-CE) signaling.

A scheduler 154 may be coupled to the processor 142. The scheduler 154 may be included within or operated separately from the T-TRP 102A, which may schedule uplink, downlink, and/or backhaul transmissions, including issuing scheduling grants and/or configuring scheduling-free (for example, “configured grant”) resources. The T-TRP 102A may further comprise a memory 150 for storing information and data. The memory 150 stores instructions and data used, generated, or collected by the T-TRP 102A. For example, the memory 150 may store software instructions or modules configured to implement some or all of the functionality and/or implementations described herein and that are executed by the processor 142.

Although not illustrated, the processor 142 may form part of the transmitter 144 and/or receiver 146. Also, although not illustrated, the processor 142 may implement the scheduler 154. Although not illustrated, the memory 150 may form part of the processor 142.

The processor 142, the scheduler 154, the processing components of the transmitter 144, and the processing components of the receiver 146 may each be implemented by the same or different one or more processors that are configured to execute instructions stored in a memory, for example, in memory 150. Alternatively, some or all of the processor 142, the scheduler 154, the processing components of the transmitter 144, and the processing components of the receiver 146 may be implemented using dedicated circuitry, such as a field-programmable gate array (FPGA), a graphical processing unit (GPU), or an application-specific integrated circuit (ASIC).

Although the NT-TRP 102B is illustrated as a drone only as an example, the NT-TRP 102B may be implemented in any suitable non-terrestrial form, such as satellites and high altitude platforms, including international mobile telecommunication base stations and unmanned aerial vehicles, for example. Also, the NT-TRP 102B may be known by other names in some implementations, such as a non-terrestrial node, a non-terrestrial network device, or a non-terrestrial base station.

The NT-TRP 102B comprises one or more circuits (such as one or more electronic circuits and/or one or more optical circuits) forming various components, and may have a similar structure as the T-TRP 102A. For example, the NT-TRP 102B may comprise a transmitter 144 and a receiver 146 coupled to one or more antennas 148. Only one antenna 148 is illustrated to avoid congestion in the drawing. One, some, or all of the antennas may alternatively be panels. The transmitter 144 and the receiver 146 may be integrated as a transceiver. The NT-TRP 102B further includes at least one processor 142 for performing operations including those related to: preparing a transmission for downlink transmission to the UE 114, processing an uplink transmission received from the UE 114, preparing a transmission for backhaul transmission to T-TRP 102A, and processing a transmission received over backhaul from the T-TRP 102A. Processing operations related to preparing a transmission for downlink or backhaul transmission may include operations such as encoding, modulating, precoding (for example, MIMO precoding), transmit beamforming, and generating symbols for transmission. Processing operations related to processing received transmissions in the uplink or over backhaul may include operations such as receive beamforming, and demodulating and decoding received symbols. In some implementations, the processor 142 implements the transmit beamforming and/or receive beamforming based on beam direction information (for example, BAI) received from T-TRP 102A. In some implementations, the processor 142 may generate signaling, for example, to configure one or more parameters of the UE 114. In some implementations, the NT-TRP 102B implements physical layer processing, but does not implement higher layer functions such as functions at the medium access control (MAC) or radio link control (RLC) layer. As this is only an example, more generally, the NT-TRP 102B may implement higher layer functions in addition to physical layer processing.

The NT-TRP 102B further includes a memory 150 for storing information and data. Although not illustrated, the processor 142 may form part of the transmitter 144 and/or receiver 146. Although not illustrated, the memory 150 may form part of the processor 142.

The processor 142, the processing components of the transmitter 144, and the processing components of the receiver 146 may each be implemented by the same or different one or more processors that are configured to execute instructions stored in a memory, for example, in memory 150. Alternatively, some or all of the processor 142, the processing components of the transmitter 144, and the processing components of the receiver 146 may be implemented using dedicated circuitry, such as a programmed FPGA, a hardware accelerator (for example, a GPU or artificial intelligence (AI) accelerator), or an ASIC. In some implementations, the NT-TRP 102B may actually be a plurality of NT-TRPs that are operating together to serve the UE 114, for example, through coordinated multipoint transmissions.

The T-TRP 102A, the NT-TRP 102B, and/or the UE 114 may include other components, but these have been omitted for the sake of clarity.

The UE 114 comprises one or more circuits (such as one or more electronic circuits and/or one or more optical circuits) forming various components. More specifically, the UE 114 includes a transmitter 200 and a receiver 202 coupled to one or more antennas 204. Only one antenna 204 is illustrated to avoid congestion in the drawing. One, some, or all of the antennas may alternatively be panels. The transmitter 200 and the receiver 202 may be integrated, for example, as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The UE 114 includes at least one memory 208. The memory 208 stores instructions and data used, generated, or collected by the UE 114. For example, the memory 208 may store software instructions or modules configured to implement some or all of the functionality and/or implementations described herein and that are executed by at least one processing unit (for example, the at least one processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The UE 114 may further include one or more input/output devices (not shown) or interfaces (such as a wired interface to the internet 108 in FIG. 1A). The input/output devices permit interaction with a user or other devices in the network. Each input/output device includes any suitable structure for providing information to or receiving information from a user, and/or for network interface communications. Suitable structures include, for example, a speaker, a microphone, a keypad, a keyboard, a display, a touch screen, a network interface, and/or the like.

The UE 114 further includes at least one processor 210 for performing operations including those operations related to preparing a transmission for uplink transmission to the T-TRP 102A and/or NT-TRP 102B, those operations related to processing downlink transmissions received from the T-TRP 102A and/or NT-TRP 102B, and those operations related to processing sidelink transmission to and from another UE 114. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the implementation, a downlink transmission may be received by the receiver 202, possibly using receive beamforming, and the processor 210 may extract signaling from the downlink transmission (for example, by detecting and/or decoding the signaling). An example of signaling may be a reference signal transmitted by the T-TRP 102A and/or NT-TRP 102B. In some implementations, the processor 142 implements the transmit beamforming and/or the receive beamforming based on the indication of beam direction, for example, beam angle information (BAI), received from T-TRP 102. In some implementations, the processor 210 may perform operations relating to network access (for example, initial access) and/or downlink synchronization, such as operations relating to detecting a synchronization sequence, decoding and obtaining the system information, and/or the like. In some implementations, the processor 210 may perform channel estimation, for example, using a reference signal received from the T-TRP 102A and/or NT-TRP 102B.

Although not illustrated, the processor 210 may form part of the transmitter 200 and/or part of the receiver 202. Although not illustrated, the memory 208 may form part of the processor 210.

The processor 210, the processing components of the transmitter 200, and the processing components of the receiver 202 may each be implemented by the same or different one or more processors that are configured to execute instructions stored in a memory (for example, in memory 208). Alternatively, some or all of the processor 210, the processing components of the transmitter 200, and the processing components of the receiver 202 may be implemented using dedicated circuitry, such as a programmed FPGA, an ASIC, or a hardware accelerator such as a GPU or an AI accelerator.

One or more steps of the implementation methods provided herein may be performed by corresponding units or modules, according to FIG. 2B. FIG. 2B illustrates units or modules in a device, such as in a UE 114 or in a TRP 102. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the UEs 114 and TRP 102 are known to those of skill in the art. As such, these details are omitted here.

MIMO technology allows an antenna array of multiple antennas to perform signal transmissions and receptions to meet high transmission rate requirement. The UEs 114 and/or TRPs 102 may use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above TRP 102 configured with a large number of antennas has gained wide attentions from the academia and the industry. In the large-scale MIMO system, the TRP 102 may be generally configured with more than ten antenna units (such as antennas 148 shown in FIG. 2A), and serves for dozens of the UE 114 in the meanwhile. A large number of antenna units of the TRP 102 may greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the TRP 102 of each cell may communicate with many UEs 114 in the cell on the same time-frequency resource at the same time, thus greatly increasing the spectrum efficiency. A large number of antenna units of the TRP 102 also enable each user to have improved spatial directivity for uplink and downlink transmission, so that the transmitting power of the TRP 102 and/or a UE 114 is obviously reduced, and the power efficiency is greatly increased. When the antenna number of the TRP 102 is sufficiently large, random channels between each UE 114 and the TRP 102 may approach to be orthogonal, and the interference between the cell and the users and the effect of noises may be eliminated. The plurality of advantages described above enable the large-scale MIMO to have a magnificent application prospect.

A MIMO system may include a receiver connected to a receiving (Rx) antenna, a transmitter connected to transmitting (Tx) antenna, and a signal processor connected to the transmitter and the receiver. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some implementations of a MIMO system include:

Panel: unit of antenna group, or antenna array, or antenna sub-array which may control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, antenna port(s) identifier, channel state information reference signal (CSI-RS) resource identifier, SSB resource identifier, sounding reference signal (SRS) resource identifier, codebook indication, beam direction indication, other reference signal resource identifier, and/or the like.

An important task of the physical layer of a communication system 100 is symbol detection, wherein the goal is to minimize the error probability of the detected symbols.

As shown in FIG. 3, the main components of the communication system 100 include a transmitter 242, a receiver 246, and a channel 244 (such as a wireless channel) therebetween. Since the wireless channel 244 is an uncontrollable part, the transmitter 242 and receiver 246 are designed to be able to track the channel changes and mitigate the impact of the channel uncertainties such as noises and interferences. For example, the transmitter 242 may repeatedly send known signals such as pilot signals through the channel 244 to the receiver 246 for the receiver 246 to use these pilot signals to estimate the channel 244 and equalize the received symbols and detect them, using suitable methods. For example, the least square (LS) method may be used for channel estimation and the linear minimum mean square error (LMMSE) method may be used for equalization.

FIG. 4 is a schematic diagram showing the structure of a receiver 246′ using orthogonal frequency-division multiplexing (OFDM). As shown, the received signal 252 is first converted to the frequency domain using the fast Fourier transform (FFT) 254. As described above, the pilot signals or symbols in the received signal 252 are used for channel estimation 256. Based on the estimated channel information, an equalizer 258 is used for compensating for the channel impactions such as channel distortion, noises, and interferences. The equalized OFDM signal or symbol is then passed through a demapper 260, a rate de-matching module 262, and a decoder 264 for outputting the detection signal or symbol.

More specifically, in the receiver 246′, the received pilot signals in every resource grid are used to estimate the channels 244 of every symbol in the grid. These estimated channels 244 are used to equalize the symbols. Then, the demapper 260 calculates the log-likelihood ratios (LLRs) of the bits is used. As described above, the LS method may be used for channel estimation, and the LMMSE may be used for equalization.

A drawback of these receivers (such as the receiver 246′) is that, due to the rapid change of the wireless channels 244, it is often difficult to adequately track channel changes (for example, using pilot signals). Accordingly, the bit error rate (BER) performance of these receivers (such as the receiver 246′) is often low. The gap between the perfect receiver (which assumes the channels 244 are perfectly known) and these receivers (such as the receiver 246′) is high. In addition, these receivers (such as the receiver 246′) may not exploit the temporal, spectral, and the spatial correlation to improve the detection performance. Furthermore, in case of interference presence, these (such as the receiver 246′) receivers often consider the interference as noise, which maximizes their negative impact on the overall performance.

Artificial intelligence (AI) methods such as deep learning (DL) methods have been disclosed for detecting received OFDM symbols and have shown high improvement compared to the signal-detection methods (for example, estimating the channels using the LS method and detecting the OFDM symbols using the LMMSE method).

The improvements of the DL methods in detecting OFDM received symbols are primarily due to the ability of neural networks to extract and leverage temporal, spectral, and spatial correlations to enhance signal detection performance. Additionally, these networks may learn interference patterns and develop strategies to mitigate the effects thereof on detection accuracy. Neural models may replace individual functions in wireless receivers 246, such as the channel estimator 256.

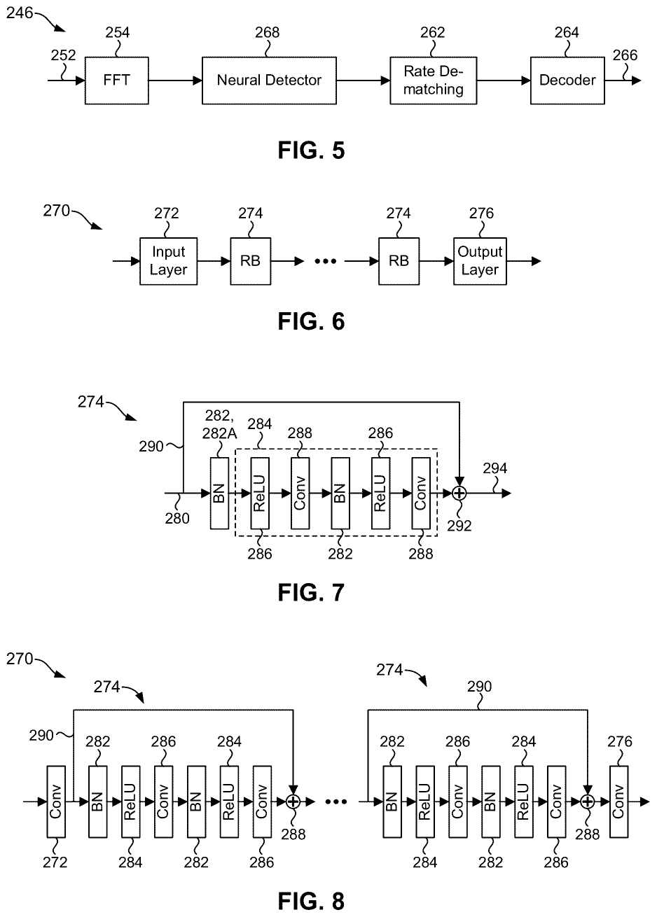

Alternatively, as shown in FIG. 5, a neural-network-based receiver 246 may use a neural-network signal detector 268 having one or more neural models to replace a sequence of functions such as the channel estimator 256, the equalizer 258, and the demapper 260. It is seen that deep models, when applied to multiple receiver functions, tend to outperform the use of individual models for each function.

In some applications, convolutional neural networks (CNNs) that calculates the log-likelihood ratios (LLRs) may be used for channel estimation 256, equalization 258, and/or demapping 260, which may provide improved performance compared to some methods used for channel estimation, equalization, and/or demapping.

In some other applications, wherein a multi-layer perceptron neural network may be used to replace multiple functions in the receiver 246, and jointly estimate the channels and detect the signals. For example, a CNN may be used to directly detect the signals from the received time-domain signals.

In some applications, end-to-end DL methods may be used in the communication system 100, wherein both the transmitter 242 and the receiver 246 comprise DL models that are jointly trained to detect and form the signals.

In some applications, the communication system 100 may use a CNN with residual connections to handle the received frequency-domain OFDM signals and provide the soft bits as outputs.

For example, some convolutional DL receivers that utilize the frequency and temporal correlations in addition to the pilot signals in every received resource grid to improve the produced soft bits, which leads to minimizing the BER. The DeepRx signal receiver uses a neural architecture which is a type of residual network (ResNet) called pre-activation ResNet. In some applications, the architecture of DeepRx is used to develop an iterative neural network that may detect the received symbols iteratively. In some applications, graph neural networks are used to develop a decoding method at the wireless receivers.

FIG. 6 is a schematic diagram showing the structure of the pre-activation ResNet 270. As shown, the pre-activation ResNet 270 comprises a plurality of layers connected in series, including an input layer 272, a plurality of residual blocks (RBs) 274, and an output layer 276.

FIG. 7 shows the structure of an RB 274, which comprises a normalization operation, such as a batch normalization (NB) 282 or layer normalization (LN), receiving the input 280 of the RB 274, and fetching the normalized input to a suitable neural network module 284 such as a CNN module (which may comprise a plurality of layers such as one or more rectified linear units (ReLUs) 286, one or more NBs 282, and one or more convolutional layers 288 as required or desired).

The RB 274 also comprises a shortcut 290 (also called a “skip connection”) directly connecting the input 280 of the RB 274 to the output side, at which the input 280 of the RB 274 and the output of the neural network module 284 are added together (292) to form the output 294 of the RB 274. Notably, the shortcut 290 of the RB 274 is not normalized.

FIG. 8 shows an example of a pre-activation ResNet 270 comprising a plurality of RBs 274, wherein each RB 274 comprises a CNN module. In this example, each of the input layer 272 and the output layer 276 is a convolution layer.

In the DL-based receivers, the one that utilizes one neural network to jointly estimate the channels, equalize the symbols, and demap the symbols into soft bits (such as the one shown in FIG. 5) may give rise to better performances compared to other DL-based receivers. Other receivers such as those using iterative operations to gradually improve the detection performance, may suffer from high computational cost.

While some DL approaches may be promising in improving the performance of wireless receivers, they have several disadvantages. For example, most neural networks employed in radio receivers are either standard CNNs or ResNets, or networks adopted from other domains (such as the computer vision field). While these architectures perform well in many applications, they may not be suitable for the specific needs of communication systems such as wireless communication systems.

Another challenge arises when the neural networks are large and deep, which is typically the case for achieving high performance in complex tasks like signal detection. While deeper networks can provide better accuracy, they come with substantial drawbacks, including large memory requirements, high computational costs, increased inference delays, and/or the like. These issues are problematic, for example, in real-time applications and embedded systems, where resources are limited, and low latency is required.

Moreover, reducing the size of these neural networks, such as by limiting the number of layers or parameters thereof, may lead to a drop in the receiver's performance. The trade-off between network complexity and performance is an issue in wireless receiver design, as a small reduction in neural network size may substantially degrade detection accuracy and the overall reliability of the communication system. Therefore, the need for highly accurate models often conflicts with the practical constraints of memory and processing power, thereby making it difficult to deploy these models in resource-constrained environments such as mobile or edge devices.

In the following, various implementations of a collaborative neural network (CoNet) signal detector, which may be used as the neural-network signal detector 268 for a wireless receiver in an OFDM communication system 100. Compared to some DL-based receivers, the CoNet signal detector 268 allows smaller number of parameters and/or smaller number of layers, while providing improved performance.

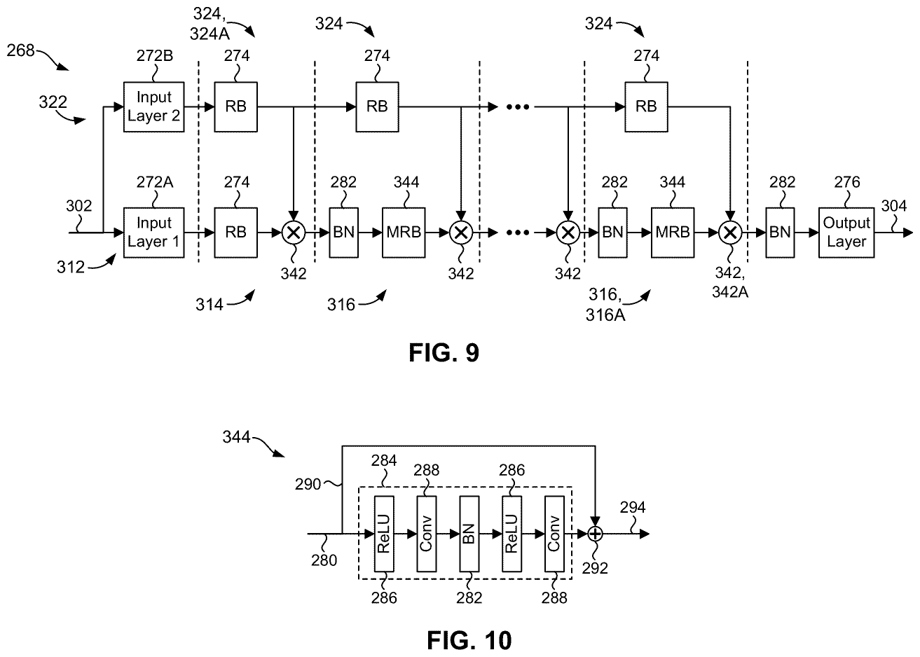

FIG. 9 is a schematic diagram showing the structure of a CoNet signal detector 268, according to some implementations of this disclosure. In this example, the input signal 302 is a signal suitable for signal detection, such as the received signal (received by the receiver 246), a preprocessed signal obtained from the received signal after suitable preprocessing (such as amplification, demodulation, and/or the like), a received OFDM signal converted from the received signal by an FFT operation 254, or the like. As described above, the received signal may comprise pilot signals that are known by the receiver 246 (and thus the CoNet signal detector 268). When OFDM is used, the received signals are formed in an OFDM resource grid.

The output signal 304 is a detected signal or symbol corresponding to the signal or symbol transmitted by the transmitter 242 (which may be ideally the same as the transmitted signal but may contain one or more errors in practice).

As shown in FIG. 9, the CoNet signal detector 268 comprises two branches 312 and 322, each comprising a ResNet. The two ResNets process the input signal 302 in parallel through the layers thereof to provide diversified information that will then be fused to improve the BER performance. For example, one ResNet may be used to understand the channel correlations across the symbols, while the other ResNet may be used to understand the interference pattern. The information obtained from the two ResNets is integrated across the layers by suitable operations such as element-wise multiplication, addition, concatenation, and/or the like.

More specifically, the first ResNet 312 (also denoted the “main ResNet”) comprises a plurality of sequentially connected layers including an input layer 372A (denoted “input layer 1” in FIG. 9), an RB layer 314, and one or more modified RB (MRB) layers 316. The RB layer 314 comprises an RB 274 followed by a multiplicator 342 (performing element-wise multiplication). Each of the one or more MRB layers 316 comprises a BN 282 followed by a MRB 344 (described in more detail later) and then a multiplicator 342. The output of the multiplicator 342A in the last MRB layer 316A is sent to a BN 282 for normalization, which is then passed through an output layer 276 for generating the output signal 304.

The second ResNet 322 (also denoted the “support ResNet”) comprises a plurality of sequentially connected layers including an input layer 372B (denoted “input layer 2” in FIG. 9) and a plurality of RB layers 324. The first RB layer 324A of the support ResNet 322 corresponds to the RB layer 314 of the main ResNet 312, and each of the other RB layers 324 corresponds to an MRB layer 316 of the main ResNet 312.

Each RB layer 324 of the support ResNet 322 comprises an RB 274, the output of which is sent to the RB of the next RB layer in the support ResNet 322, and is also sent to the multiplicator 342 of the corresponding layer 314 or 316 in the main ResNet 312.

FIG. 10 is a schematic diagram showing the structure of an MRB 344. As can be seen, the MRB 344 is similar to the RB 274 except that the MRB 344 does not comprise the leading BN 282A (see FIG. 7). However, as each MRB 344 follows a BN 282, both the signal sent to the neural network module 284 (which is a CNN module in this example) and the signal passing through the shortcut 290 are normalized, which stabilizes the network and avoid having gradient explosion. On the other hand, in each RB 274, the signal passing through the shortcut 290 is not normalized.

As those skilled in the art will appreciate, the CoNet signal detector 268 may be trained by transmitting known signals from the transmitter 242 to the receiver 246, which may be conducted through simulation and/or in-field testing. The CoNet signal detector 268 may also be trained while in use (for example, using the pilot signals and/or the decoding results).

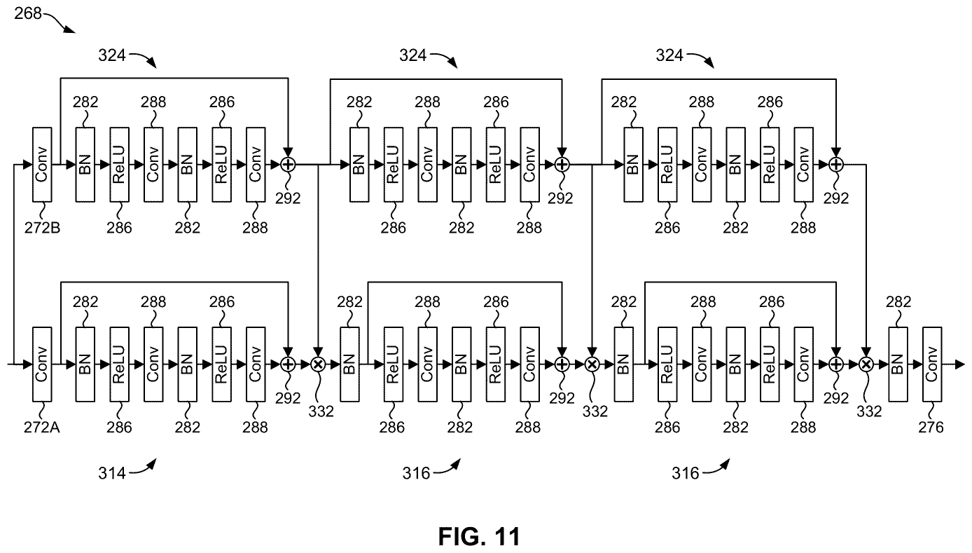

FIG. 11 is a schematic diagram showing the structure of an example of the CoNet signal detector 268. In this example, the main ResNet 312 comprises a convolutional layer 272A as the input layer, an RB layer 314, and two MRB layers 316. Correspondingly, the support ResNet 322 comprises a convolutional layer 272A as the input layer, and three RB layers 324. Each RB 274 or MRB 344 comprises a CNN module having two convolutional layers 274. Therefore, each ResNet 312, 322 has seven (7) convolutional layers.

Thus, the input signal 302 is processed in parallel by both ResNets 312 and 322 over the layers thereof. Element-wise multiplication 342 is conducted between the activations of the ResNets 312 and 322 at each layer. The result of the multiplication is normalized (using a BN 274 or alternatively using an LN) and then fed into the next layer of the main ResNet 312.

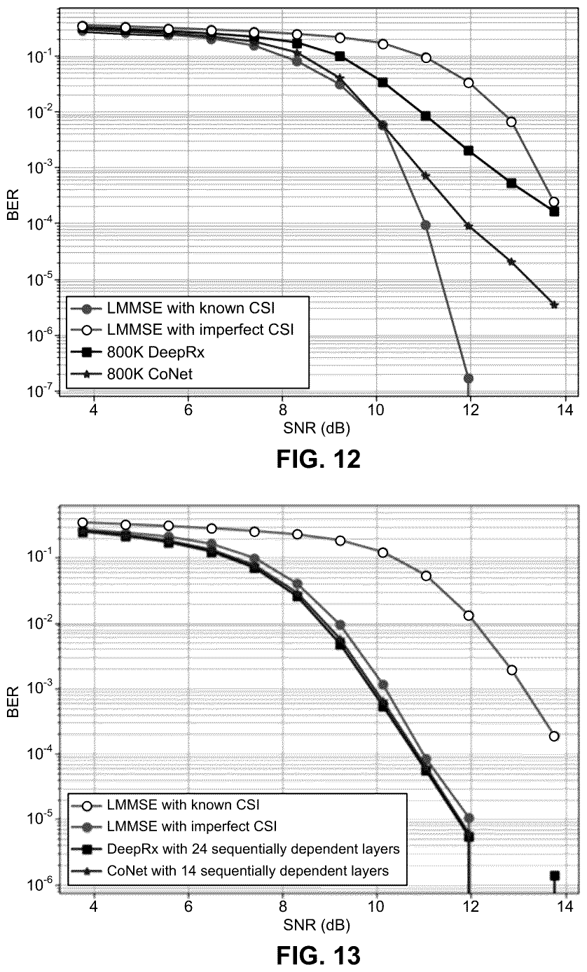

FIG. 12 is a plot showing the simulated BER performances of the CoNet signal detector 268 having an RB layer 314 and three (3) MRB layers 316 in the main ResNet 312 and accordingly four (4) RB layers 324 in the support ResNet 322, a DeepRx signal detector, a signal detector using LMMSE with known channel state information (CSI), and a signal detector using LMMSE with imperfect CSI, respectively. The number of parameters in each signal detector is around 800K (that is, around 800,000 parameters in each signal detector) and the depth of the ResNets in each model is 10 layers (the DeepRx signal detector has one input layer, four (4) RBs, and one (1) output layer; in the CoNet signal detector 268, a pair of parallel convolutional layers 288 in the two branches 312 and 322 are counted as one layer, the two parallel input layers 272A and 272B are considered as one layer, and the output layer 276 is also counted as one layer). The same dataset is used to train the models of both signal detectors.

In the simulation, the channels are simulated using time-delay-lines (TDL), with the delay spread uniformly distributed between one (1) nanosecond (ns) and 1500 ns. The user speed is uniformly distributed between 0 meter/second (m/s) and 15 m/s. The interference variance is ranging between 10% and 90% out of the total (noise and interference) given variance. The modulation scheme is 64 QAM.

As shown in FIG. 12, the CoNet 268 outperforms the DeepRx signal detector in reducing the BER.

Comparing to the DeepRx signal detector, the CoNet signal detector 268 disclosed herein has another advantage of reduced inference delay for the same performance target. As those skilled in the art understand, some neural nets perform well when they are deep. However, this introduces a delay due to the fact that the layers of these neural nets are sequentially dependent. In contrary, the CoNet signal detector 268 may require less sequentially dependent layers for achieving the same performance.

For example, FIG. 13 is another plot showing the simulated BER performances of the CoNet signal detector 268, the DeepRx signal detector, a signal detector using LMMSE with known channel state information (CSI), and a signal detector using LMMSE with imperfect CSI, respectively, wherein the CoNet signal detector 268 has an RB layer 314 and five (5) MRB layers 316 in the main ResNet 312 and accordingly six (6) RB layers 324 in the support ResNet 322, giving rise to 14 sequentially dependent layers, and the DeepRx signal detector has an input layer, 11 RBs, and an output layer, giving rise to 24 sequential convolutional layers. The number of parameters in each signal detector is around 1.9 million (M). The number of filters in each layer in the CoNet signal detector 268 is smaller than the that in the DeepRx signal detector, meaning that the CoNet signal detector 268 may decrease the inference time by around 42% compared to the DeepRx signal detector. As can be seen from FIG. 13, the BER performance of the CoNet signal detector 268 is virtually the same as that of the DeepRx signal detector.

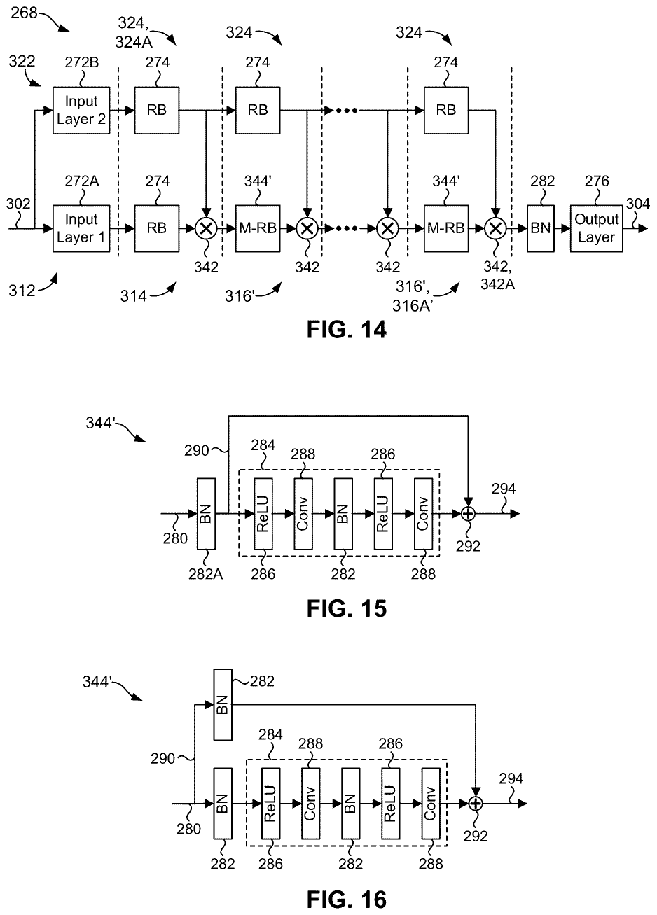

The CoNet signal detector 268 shown in FIG. 9 may alternatively be interpreted as shown in FIGS. 14 and 15.

As shown in FIG. 14, the CoNet signal detector 268 comprises two branches 312 and 322, each comprising a ResNet. The two ResNets process the input signal 302 in parallel through the layers thereof to provide diversified information that will then be fused to improve the BER performance.

More specifically, the main ResNet 312 comprises an input layer 372A, an RB layer 314 having an RB 274 followed by a multiplicator 342 (performing element-wise multiplication), and one or more modified RB (abbreviated as “M-RB” to differentiate it from the MRBs shown in FIG. 9) layers 316′ each having a M-RB 344′ (described in more detail later) and a multiplicator 342. The output of the multiplicator 342A in the last M-RB layer 316A′ is sent to a BN 282 for normalization, which is then passed through an output layer 276 for generating the output signal 304.

The support ResNet 322 comprises an input layer 372B and a plurality of RB layers 324. The first RB layer 324A of the support ResNet 322 corresponds to the RB layer 314 of the main ResNet 312, and each of the other RB layers 324 corresponds to an M-RB layer 316′ of the main ResNet 312.

Each RB layer 324 of the support ResNet 322 comprises an RB 274, the output of which is sent to the multiplicator 342 of the corresponding layer 314 or 316 in the main ResNet 312.

FIG. 15 is a schematic diagram showing the structure of an M-RB 344′. As can be seen, the M-RB 344′ is similar to the RB 274 except that, in the M-RB 344, the output of the leading BN 282A is passed through the shortcut 290 to combine with (for example, add to) the output of the neural network module 284 (which is a CNN module in this example) to form the output of the M-RB 344′. Thus, unlike the RB 274, the input of the M-RB 344′ is normalized by the leading BN 282A before being sent to the neural network module 284 and the shortcut path 290.

FIG. 16 is a schematic diagram showing the structure of an M-RB 344′, according to some implementations of this disclosure. The M-RB 344′ is similar to the RB 274 except that the shortcut path 290 also comprises a BN 282 to ensure that the input of the M-RB 344′ is normalized when passing through the shortcut 290.

Other implementations are also readily available.

For example, in some implementations, the main ResNet 312 may comprise more than one RBs 274.

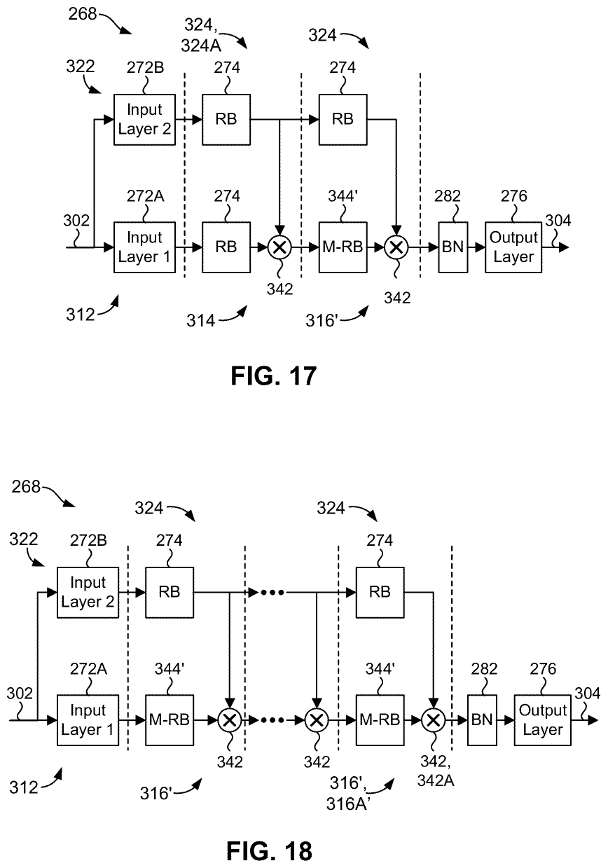

FIG. 17 is a schematic diagram showing the structure of the CoNet signal detector 268, according to some implementations of this disclosure. The CoNet signal detector 268 in these implementations is similar to that shown in FIG. 14 except that, in these implementations, the main ResNet 312 comprises a single M-RB layer 316′ having a M-RB 344′ and a multiplicator 342. Accordingly, the support ResNet 322 comprises two RB layers 324 each having an RB 274.

FIG. 18 is a schematic diagram showing the structure of the CoNet signal detector 268, according to some implementations of this disclosure. The CoNet signal detector 268 in these implementations is similar to that shown in FIG. 14 except that, in these implementations, the main ResNet 312 comprises one or more M-RB layers 316′ each having a M-RB 344′ and a multiplicator 342, and does not comprise any RB layer 314. Accordingly, the support ResNet 322 comprises one or more RB layers 324 each having an RB 274.

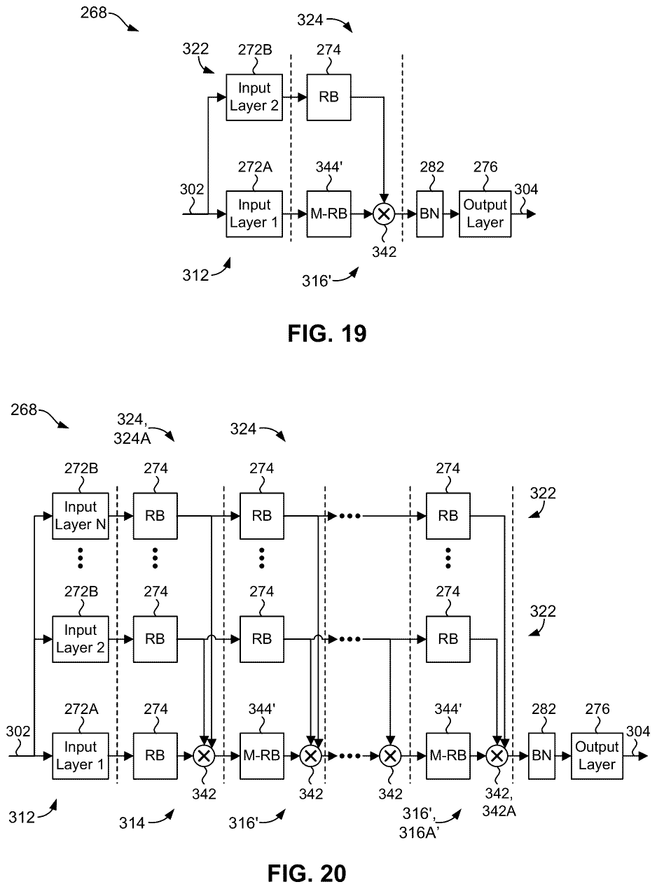

FIG. 19 is a schematic diagram showing the structure of the CoNet signal detector 268, according to some implementations of this disclosure. The CoNet signal detector 268 in these implementations is similar to that shown in FIG. 14 except that, in these implementations, the main ResNet 312 comprises a single M-RB layer 316′ having a M-RB 344′ and a multiplicator 342, and does not comprise any RB layer 314. Accordingly, the support ResNet 322 comprises a single RB layer 324 having an RB 274.

FIG. 20 is a schematic diagram showing the structure of the CoNet signal detector 268, according to some implementations of this disclosure. The CoNet signal detector 268 in these implementations is similar to that shown in FIG. 14 except that, in these implementations, the CoNet signal detector 268 comprises a plurality of support ResNets 322 each comprising one or more RB layers 324 and each RB layer 324 having an RB 274. In the example shown in FIG. 19, the plurality of support ResNets 322 are the same, and the output of each RB 274 in each of the plurality of support ResNets 322 is sent to the RB 274 of the next RB layer 324, and is also sent to the multiplicator 342 of the corresponding layer 314 or 316 in the main ResNet 312.

Those skilled in the art will appreciate that the features of various implementations (or the lacking of features thereof) may be combined.

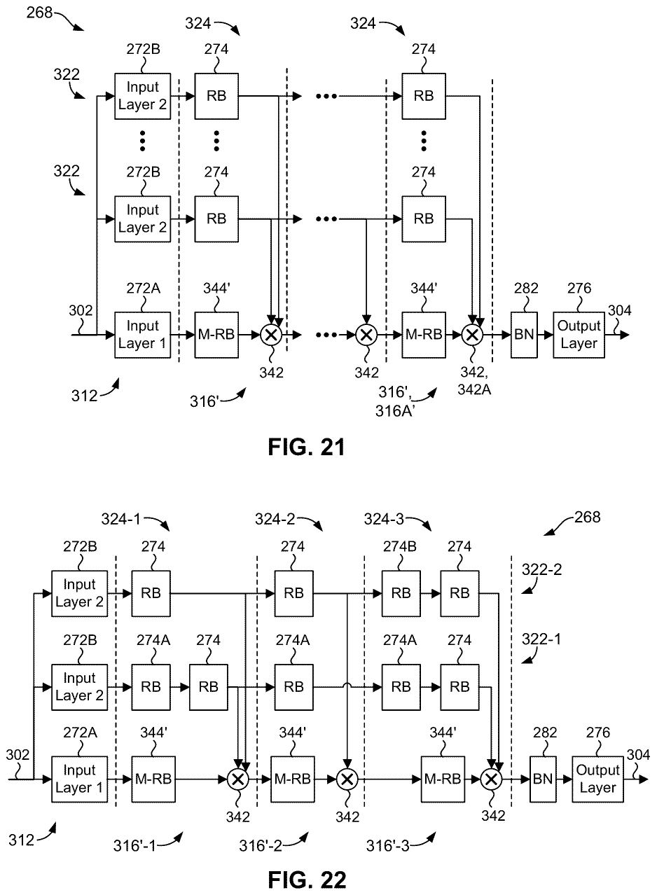

For example, FIG. 21 is a schematic diagram showing the structure of the CoNet signal detector 268, according to some implementations of this disclosure. The CoNet signal detector 268 in these implementations is similar to that shown in FIG. 20 except that, in these implementations, the main ResNet 312 of the CoNet signal detector 268 does not comprise any RB layer 314.

In above implementations, the number of the RB 274 and M-RBs 344′ of the main ResNet 312 is the same as that of the RBs 274 of each support ResNet 322. In some other implementations, the number of the RB 274 and M-RBs 344′ of the main ResNet 312 may not be the same as that of the RBs 274 of each support ResNet 322. Moreover, not all RBs 274 of the support ResNets 322 need to be connected the multiplicators 342 of the main ResNet 312.

For example, FIG. 22 is a schematic diagram showing the structure of the CoNet signal detector 268, according to some implementations of this disclosure. In this implementations, the CoNet signal detector 268 comprises two support ResNets 322-1 and 322-2. The main ResNet 312 comprises three M-RBs 344′, the support ResNet 322-1 comprises five RBs 274, and the support ResNet 322-1 comprises four RBs 274. In the support ResNet 322-1, the RBs 274A and 274B do not send their outputs to any multiplicator 342 of the main ResNet 312. In the support ResNet 322-2, the RB 274C does not send their outputs to any multiplicator 342 of the main ResNet 312.

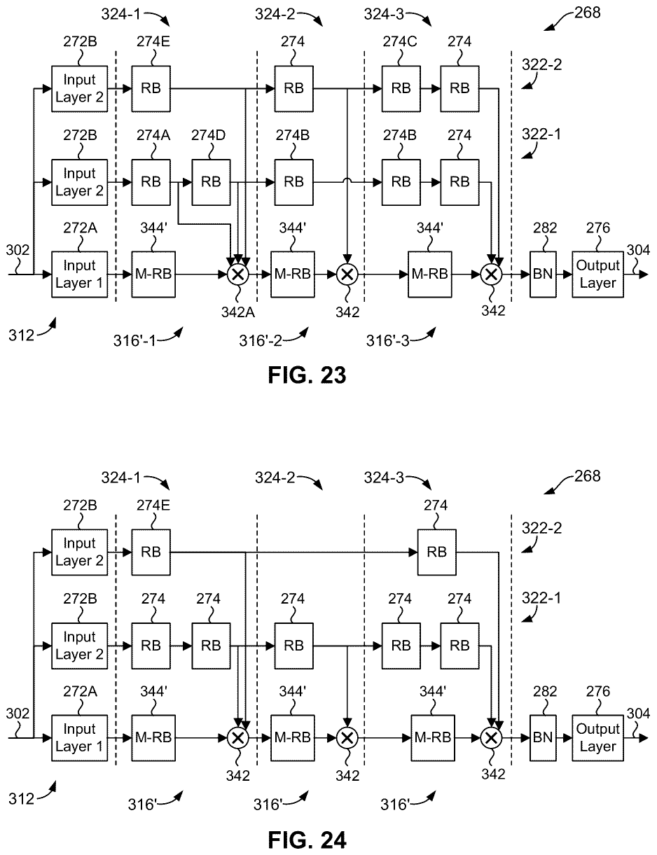

FIG. 23 is a schematic diagram showing the structure of the CoNet signal detector 268, according to some implementations of this disclosure. The CoNet signal detector 268 in this implementations is similar to that shown in FIG. 22 except that, in these implementations, the RB 274A connects its output to the multiplicator 344A such that the multiplicator 344A performs element-wise multiplication on the outputs of three RBs, that is, RBs 274A and 274D of the support ResNet 322-1, and RB 274E of the support ResNet 322-2.

Those skilled in the art will appreciate that, in various implementations, the number of RBs 274 of a support ResNet 322 may be equal to, or alternatively greater than, or alternatively smaller than the number of M-RBs 344′ and (if any) RBs 274 of the main ResNet 312.

For example, as shown in FIG. 24, the main ResNet 312 has three M-RBs 344′ and no RB 274. The support ResNet 322-1 comprises five RBs 274 which is greater than the number of M-RBs 344′ of the main ResNet 312. The support ResNet 322-2 comprises two RBs 274 which is smaller than the number of M-RBs 344′ of the main ResNet 312.

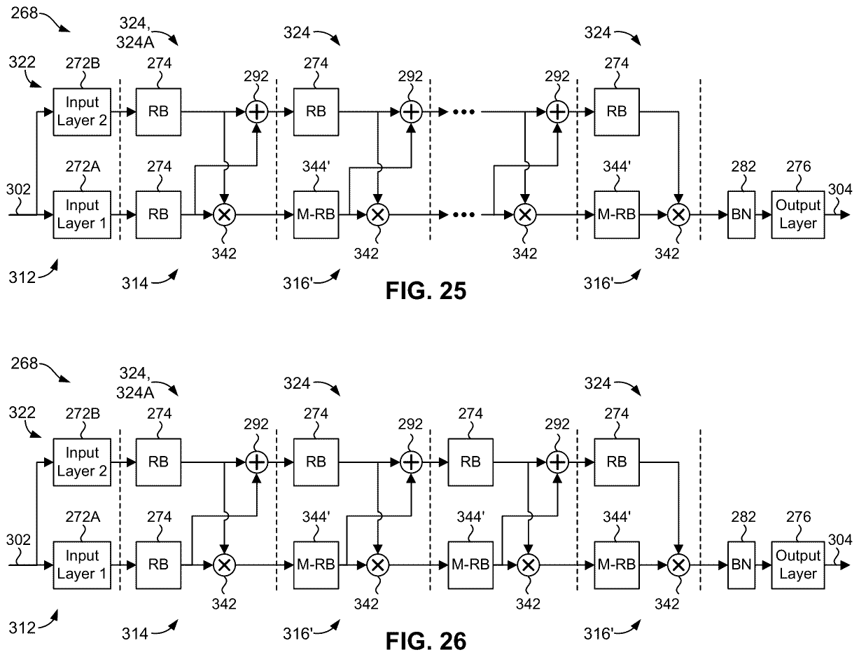

FIG. 25 is a schematic diagram showing the structure of the CoNet signal detector 268, according to some implementations of this disclosure. The CoNet signal detector 268 in these implementations is similar to that shown in FIG. 14 except that, in these implementations, each of at least a subset of RB 274 (if any) and the M-RBs 344′ of the main ResNet 312 send the output thereof to one or more of the support ResNets 322 to add (292) to the output of a corresponding RB 274 of each of the one or more of the support ResNets 322. The CoNet signal detector 268 in these implementations provides improved performance when depth-wise convolutions are used and when the number of layers of the supporting ResNet is not large.

FIG. 26 shows an example, wherein the main ResNet 312 comprises one RB 274 and three M-RBs 344′. Each of the RB 274 and M-RBs 344′ of the main ResNet 312 directs its output to the support ResNet 322 and adds (292) to the output of a corresponding RB 274 of the support ResNet 322.

FIG. 27 shows another example, wherein the CoNet signal detector 268 is similar to that shown in FIG. 26 except that the M-RB 344B′ of the main ResNet 312 does not provide its output to the support ResNet 322.

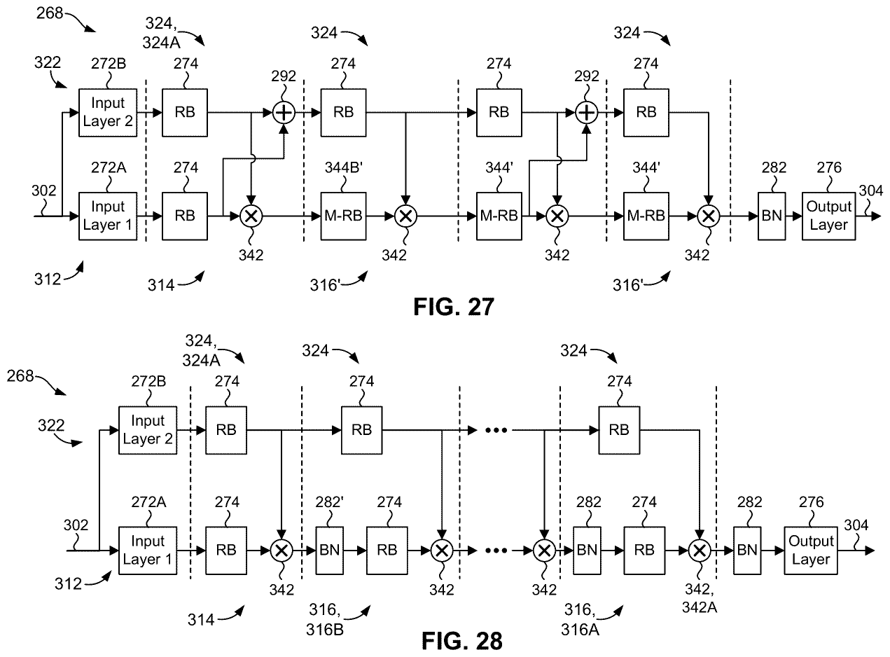

FIG. 28 is a schematic diagram showing the structure of the CoNet signal detector 268, according to some implementations of this disclosure. The CoNet signal detector 268 in these implementations is similar to that shown in FIG. 9 except that, in at least one of the one or more MRBs layers 316, such as the MRB layer 316B, the MRB 344 thereof (which does not comprise the leading BN 282; see FIG. 10) may be replaced with an RB 274 (which comprises the leading BN 282; see FIG. 7). In other words, such an MRB layer 316B comprises a leading BN 282′, an RB 274, and an elementwise multiplicator 342. However, the leading BN 282′ of the MRB layer 316B or the leading BN 282 in the RB 274 is redundant.

Those skilled in the art will appreciate that, in various implementations, the convolutional layers 288 may use standard or depth-wise convolutions.

While in above implementations, BNs 282 are used for normalization, in some implementations, at least some of the BNs 282 may substituted by LNs.

In above implementations, the same input signal of the CoNet signal detector 268 is provided to the main ResNet 312 and the one or more support ResNets 322. In some implementations, the input signal of the CoNet signal detector 268 is provided to the main ResNet 312. However, at least one of the one or more support ResNets 322 only receives a partial or a portion of the input signal (such as the pilot signals in the input signal).

In some implementations, each of the main ResNet 312 and the one or more support ResNets 322 of the CoNet signal detector 268 may comprise an input layer and one or more RBs 274 connected in series, and zero, one, or more RBs 274 in the one or more support ResNets 322 may direct the outputs thereof to the main ResNet 312 for combination (such as via elementwise multiplication, addition, and/or concatenation).

If any RB 274 in the one or more support ResNets 322 directs the outputs thereof to the main ResNet 312 to combine with (such as via elementwise multiplication, addition, and/or concatenation) the output of a block 274-1 of the main ResNet 312 for forming a combined signal to input to the subsequent block 274-2 of the main ResNet 312, the shortcut path of the subsequent block 274-2 is normalized (such as using a BN or LN) before adding to the output of the neural network module 284 of the subsequent block 274-2. In other words, the subsequent block 274-2 is a M-RB 344′. On the other hand, if a block of the main ResNet 312 is not subsequent to an output combination, then the block is an RB 274.

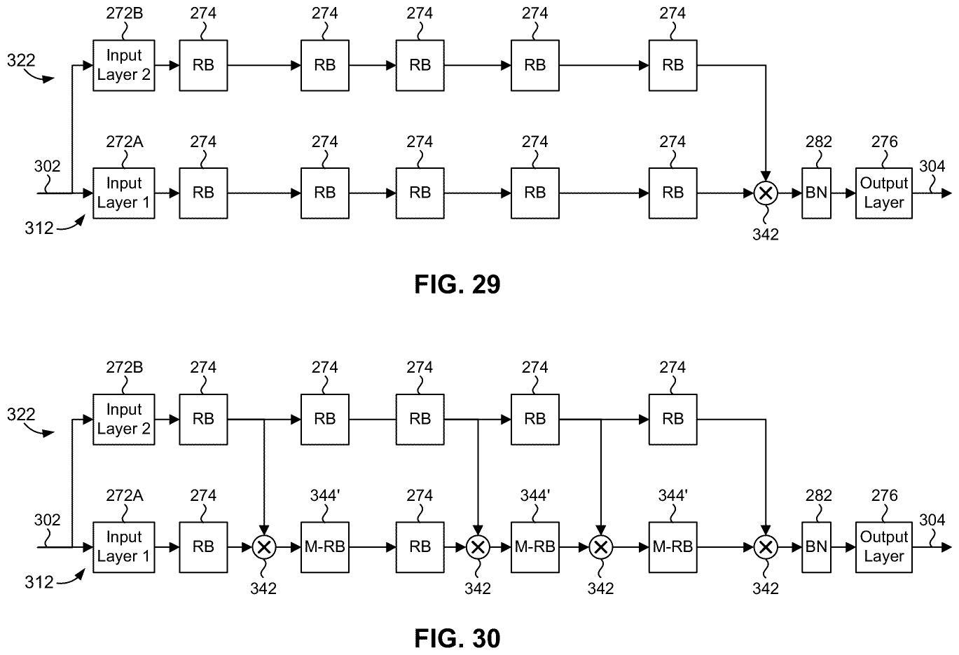

For example, as shown in FIG. 29, the CoNet signal detector 268 comprises a main ResNet 312 and a support ResNet 322, each having a plurality of RBs 274, wherein no RB 274 of the support ResNet 322 directs its output to the main ResNet 312. Therefore, no RB 274 of the main ResNet 312 normalizes its shortcut path.

As shown in FIG. 30, in the CoNet signal detector 268 (which is similar to that shown in FIG. 29), some of the RBs 274 in the support ResNet 322 direct their outputs to the main ResNet 312 to combine with the outputs of respective blocks (being RBs or M-RBs depending on whether or not they are subsequent to an output combination). Then, in the blocks subsequent to each output combination, the shortcut path thereof is normalized, and the block is a M-RB 344′.

The CoNet signal detector 268 disclosed herein may be used in various signal receivers, such as signal receivers in wireless communication systems. For example, the CoNet signal detector 268 disclosed herein may be used in a receiver with single or multiple antennas, operating in the microwave or millimeter wave (mmWaves) bands, for mobiles or fixed stations, for any order of modulations or any type of coding schemes, and/or the like.

The CoNet signal detector 268 disclosed herein may be used to solve various problems in communication systems, such as wireless communication systems, and other suitable systems, for example, when there are multiple patterns in the input signals that are required to be recognized.

The CoNet signal detector 268, and the related apparatuses (such as the signal receiver), systems, and methods disclosed herein provide various benefits.

For example, the CoNet signal detector 268, and the related apparatuses (such as the signal receiver), systems, and methods disclosed herein leverage the collaboration of multiple ResNets to improve the detection performance of the radio receivers. Compared to most signal detectors, the CoNet signal detector disclosed herein reduces the BER, and may achieve the same performance target as said most signal detectors with fewer number of parameters and fewer computational operations, thereby reducing the memory and computational cost.

By using a normalization layer after each element-wise multiplication that occurred between the ResNets, the features that go through the neural network module and the shortcut path are normalized, which helps stabilizing the neural networks and avoiding the gradient explosion phenomena.

Different from the standard ResNets where the operations are fully sequentially dependent, the CoNet signal detector disclosed herein uses multiple ResNets to process features in parallel, which helps reducing the inference delay.

| | Acronym/ |
|---|---|
| | Abbreviation/ |
| Full Name | Initialism |
| Batch Normalization | BN |
| Bit Error Rate | BER |
| Collaborative Networks | CoNet |
| Convolutional Neural Network | CNN |
| Deep Learning | DL |
| Fast Fourier Transform | FFT |
| Layer Normalization | LN |
| Least Square | LS |
| Linear Minimum Mean Square Error | LMMSE |
| Log-Likelihood Ratio | LLR |
| Modified Residual Block | MRB |
| Neural Network | NN |
| Orthogonal Frequency-Division Multiplexing | OFDM |
| Quadrature Amplitude Modulation | QAM |
| Residual Block | RB |
| Residual Network | ResNet |
| Time Delay Line | TDL |

Herein, the term “signal detection” refers to detecting an informative signal from an input signal, wherein the input signal may be a signal transmitted from a transmitter and received by a receiver, or a processed and/or transformed version thereof.

Herein, a “module” is a term of explanation referring to a hardware structure such as a circuitry implemented using technologies such as electrical and/or optical technologies (and with more specific examples of semiconductors) for performing defined operations or processings. A “module” may alternatively refer to a software structure executable by a hardware structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As a part of a device, an apparatus, a system, and/or the like, a module may be coupled to or integrated with other parts of the device, apparatus, or system such that the combination thereof forms the device, apparatus, or system. Alternatively, the module may be implemented as a standalone device or apparatus.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured (for example, by a TRP 102) before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various implementations of the DM-based framework and method are described. In various implementations, the methods disclosed herein may be implemented as hardware, software, firmware, or a combination thereof, and may be implemented in any suitable form. Depending on the functionalities of various features of the methods disclosed herein, some features may be implemented on the network side (such as in one or more TRPs), some other features may be implemented on the UE side, and/or yet some other features may be implemented on both the TRP and the UE sides. Depending on the functionalities of various features of the methods disclosed herein, some features may be implemented on the transmitting side (such as in one or more TRPs and/or one or more UEs for transmission), some other features may be implemented on the receiving side (such as in one or more TRPs and/or one or more UEs for receiving), and/or yet some other features may be implemented on both the transmitting and the receiving sides.

For example, in some implementations, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some implementations, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some implementations, an apparatus may not have any processors or computer-readable storage devices or media. Rather, the apparatus may comprise any other suitable physical or virtual (explained below) components for implementing the methods disclosed herein.

In some implementations, the computer-executable instructions that implement the methods disclosed herein may be one or more computer programs, one or more program products, or a combination thereof.

In some implementations, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various implementations, including not only method implementations, but also other implementations such as apparatus implementations and implementations related to non-transitory computer readable storage media. Implementations may incorporate, individually or in combinations, the features disclosed herein.

Although this disclosure refers to illustrative implementations, this is not intended to be construed in a limiting sense. Various modifications and combinations of the illustrative implementations, as well as other implementations of the disclosure, will be apparent to persons skilled in the art upon reference to the description.

Features disclosed herein in the context of any particular implementations may also or instead be implemented in other implementations. Method implementations, for example, may also or instead be implemented in apparatus, system, and/or computer program product implementations. In addition, although implementations are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described implementations and/or features thereof may be customized, separated, and/or combined as needed or desired. Moreover, although implementations have been described above with reference to the accompanying drawings, those of skill in the art will appreciate that variations and modifications may be made without departing from the scope thereof as defined by the appended claims.

What is claimed is:

1. A signal detection method comprising:
passing an input signal through a first branch;
passing at least a respective portion of the input signal through each of one or more second branches;
combining output signals of the first branch and the one or more second branches to obtain a combined signal;
normalizing the combined signal; and
passing the normalized signal through an output layer for outputting a detected signal;
wherein each of the first branch and the one or more second branches comprises an input layer and one or more residual blocks (RBs) connected in series;
wherein each RB is for:
passing a normalized version of an input signal of the RB through a neural network module for generating an inference, and
summing the input signal of the RB and the inference for generating an output signal of the RB.

2. The signal detection method of claim 1, wherein said combining the output signals of the first branch and the one or more second branches comprises:
combining the output signals of the first branch and the one or more second branches via:
an elementwise multiplication;
an addition;
a concatenation;
or a combination thereof.

3. The signal detection method of claim 1, wherein said normalizing the combined signal comprises:
normalizing the combined signal using a first normalization layer; and
wherein said passing the normalized version of the input signal of the RB through the neural network module comprises:
normalizing the input signal of the RB using a second normalization layer to obtain the normalized version of the input signal of the RB, and
passing the normalized version of the input signal of the RB through the neural network module for generating the inference.

4. The signal detection method of claim 1, wherein the input layer of each of the first branch and the one or more second branches is a convolutional layer; and
wherein the neural network module of each RB comprises a convolutional neural network (CNN) module.

5. The signal detection method of claim 1, wherein each of the first branch and a first one of the one or more second branches comprises a plurality of RBs; and
wherein the signal detection method further comprises:
combining the output signal of a first RB of the plurality of RBs of the first one of the one or more second branches with the output signal of a second RB of the first branch for generating the input signal of a third RB of the first branch subsequent to the second RB of the first branch; and
wherein, in the third RB of the first branch, the step of summing the input signal of the RB and the inference for generating the output signal of the RB is replaced with:
summing the normalized version of the input signal of the third RB and the inference thereof for generating the output signal of the third RB.

6. The signal detection method of claim 5, wherein said combining in each of the step of combining the output signals of the first branch and the one or more second branches and the step of combining the output signal of the first RB of the plurality of RBs of the first one of the one or more second branches with the output signal of the second RB of the first branch is conducted via:
an elementwise multiplication;
an addition;
a concatenation;
or a combination thereof.

7. The signal detection method of claim 1 further comprising:
directing an output of one of the one or more RBs of the first branch to a second one of the one or more second branches, and adding to the output of one of the one or more RBs of the second one of the one or more second branches.

8. A signal detection module comprising:
one or more processors; and
one or more memories storing instructions; wherein the instructions, when executed, cause the module to perform the signal detection method of claim 1.

9. The signal detection module of claim 8, wherein said normalizing the combined signal comprises:
normalizing the combined signal using a first normalization layer; and
wherein said passing the normalized version of the input signal of the RB through the neural network module comprises:
normalizing the input signal of the RB using a second normalization layer to obtain the normalized version of the input signal of the RB, and
passing the normalized version of the input signal of the RB through the neural network module for generating the inference.

10. The signal detection module of claim 8, wherein the input layer of each of the first branch and the one or more second branches is a convolutional layer; and
wherein the neural network module of each RB comprises a convolutional neural network (CNN) module.

11. The signal detection module of claim 8, wherein each of the first branch and a first one of the one or more second branches comprises a plurality of RBs; and
wherein the signal detection method further comprises:
combining the output signal of a first RB of the plurality of RBs of the first one of the one or more second branches with the output signal of a second RB of the first branch for generating the input signal of a third RB of the first branch subsequent to the second RB of the first branch; and
wherein, in the third RB of the first branch, the step of summing the input signal of the RB and the inference for generating the output signal of the RB is replaced with:
summing the normalized version of the input signal of the third RB and the inference thereof for generating the output signal of the third RB.

12. The signal detection module of claim 11, wherein said combining in each of the step of combining the output signals of the first branch and the one or more second branches and the step of combining the output signal of the first RB of the plurality of RBs of the first one of the one or more second branches with the output signal of the second RB of the first branch is conducted via:
an elementwise multiplication;
an addition;
a concatenation;
or a combination thereof.

13. The signal detection module of claim 8, wherein the signal detection method further comprises:
directing an output of one of the one or more RBs of the first branch to a second one of the one or more second branches, and adding to the output of one of the one or more RBs of the second one of the one or more second branches.

14. One or more non-transitory, computer-readable storage media comprising computer-executable instructions, wherein the instructions, when executed, cause one or more processors to perform the signal detection method of claim 1.

15. The one or more non-transitory, computer-readable storage media of claim 14, wherein said combining the output signals of the first branch and the one or more second branches comprises:
combining the output signals of the first branch and the one or more second branches via:
an elementwise multiplication;
an addition;
a concatenation;
or a combination thereof.

16. The one or more non-transitory, computer-readable storage media of claim 14, wherein said normalizing the combined signal comprises:
normalizing the combined signal using a first normalization layer; and
wherein said passing the normalized version of the input signal of the RB through the neural network module comprises:
normalizing the input signal of the RB using a second normalization layer to obtain the normalized version of the input signal of the RB, and
passing the normalized version of the input signal of the RB through the neural network module for generating the inference.

17. The one or more non-transitory, computer-readable storage media of claim 14, wherein the input layer of each of the first branch and the one or more second branches is a convolutional layer; and
wherein the neural network module of each RB comprises a convolutional neural network (CNN) module.

18. The one or more non-transitory, computer-readable storage media of claim 14, wherein each of the first branch and a first one of the one or more second branches comprises a plurality of RBs; and
wherein the signal detection method further comprises:
combining the output signal of a first RB of the plurality of RBs of the first one of the one or more second branches with the output signal of a second RB of the first branch for generating the input signal of a third RB of the first branch subsequent to the second RB of the first branch; and
wherein, in the third RB of the first branch, the step of summing the input signal of the RB and the inference for generating the output signal of the RB is replaced with:
summing the normalized version of the input signal of the third RB and the inference thereof for generating the output signal of the third RB.

19. The one or more non-transitory, computer-readable storage media of claim 18, wherein said combining in each of the step of combining the output signals of the first branch and the one or more second branches and the step of combining the output signal of the first RB of the plurality of RBs of the first one of the one or more second branches with the output signal of the second RB of the first branch is conducted via:
an elementwise multiplication;
an addition;
a concatenation;
or a combination thereof.

20. The one or more non-transitory, computer-readable storage media of claim 14 further comprising:
directing an output of one of the one or more RBs of the first branch to a second one of the one or more second branches, and adding to the output of one of the one or more RBs of the second one of the one or more second branches.
